(19) United States
(12) Patent Application Publication
(10) Pub. No.: US 2020/0316513 A1
(43) Pub. Date: Oct. 8, 2020

(54) FAN COIL AND AIR CLEANING SYSTEM

(71) Applicant: Carrier Corporation, Palm Beach Gardens, FL (US)

(72) Inventors: Dan Zhao, Shanghai (CN); Wei Huang, Shanghai (CN); YuHui Kuang, Shanghai (CN); Hui Zhai, Shanghai (CN); Min Yang, Shanghai (CN); Xin Zhou, Shanghai (CN)

(21) Appl. No.: 16/841,332

(22) Filed: Apr. 6, 2020

(30) Foreign Application Priority Data
Apr. 8, 2019 (CN) 201910276094.8

(51) Int. Cl. B01D 46/42; B01D 46/00; B01D 46/44; B01D 46/24

(52) U.S. Cl. CPC B01D 46/4227; B01D 46/0043; B01D 46/0016; B01D 2279/50; B01D 46/2411; B01D 46/4263; B01D 46/44

(57) ABSTRACT

A fan coil and an air purification system. The fan coil includes: a housing, the housing provided with an air inlet, a fan inside the housing which air enters via the air inlet and a coil unit; and a purification unit located near the air inlet for filtering air, the purification unit includes a filter cartridge holder that detachably fixes a filter cartridge, and a conveyer that is attached to the filter cartridge holder and moves the filter cartridge to a place accessible to personnel.

### FOREIGN PRIORITY

This application claims priority to Chinese Patent Application No. 201910276094.8, filed Apr. 8, 2019, and all the benefits accruing therefrom under 35 U.S.C. §119, the contents of which in its entirety are herein incorporated by reference.

### FIELD OF THE INVENTION

The present application belongs to the field of air conditioning, and in particular to a fan coil and an air purification system including the same.

### BACKGROUND OF THE INVENTION

Fan coils, as end devices in air conditioning systems (especially central air conditioning systems), are used in buildings to control thermal comfort and air quality. The fan coils may be mounted to a ceiling of a room or above the ceiling, on a wall or inside the wall, or on a floor or under the floor. Due to constraints in terms of hardware size and fan pressure, the removal of airborne indoor pollutants is limited in the prior art.

Since these indoor pollutants, such as PM2.5, volatile organic compounds (VOC), and decoration residues (such as formaldehyde) are harmful to health, there is a great demand for indoor air purification. Through air treatment, contents of harmful microorganisms, particles and gases in the air are reduced to a safe level. If the air purification function is integrated into the air conditioning system, the indoor environment may become clean and comfortable. However, the above assumptions are difficult to achieve easily. Firstly, air filtration creates a large differential pressure resistance that will affect subsequent heat transfer performance. Secondly, the filter needs to be replaced after being used for a period of time, otherwise it will reduce the filtration efficiency. However, if the filter is integrated into a ceiling-mounted air conditioning system, it will be difficult to replace the filter.

### SUMMARY OF THE INVENTION

At least one aspect of the present application is to provide a fan coil having an air purification function that makes it convenient to replace a filter cartridge.

The fan coil according to the present application includes: a housing, wherein the housing is provided with an air inlet, and a fan inside the housing which air enters via the air inlet and a coil unit; and a purification unit located near the air inlet for filtering air, wherein the purification unit includes a filter cartridge holder that detachably fixes a filter cartridge and a conveyer that is attached to the filter cartridge holder and moves the filter cartridge to a place accessible to personnel .

In one embodiment, the purification unit further includes an actuator that drives the filter cartridge fixed to the filter cartridge holder to change between an idle state and a working state, wherein in the idle state, the filter cartridge is oriented to follow an air path so that air bypasses the filter cartridge; and in the working state, the filter cartridge is oriented to cross the air path so that air passes through the filter cartridge. Through the above features, the filtering function can be turned off and on.

The position of the filter cartridge itself relative to the air flow path affects the state of work of the filter cartridge. When the filter cartridge is placed to follow the air flow, its position is consistent with the direction of air flow, that is, when an included angle between a direction of the filter cartridge and the direction of the air flow is 0° or 180°, the filter cartridge does not work and becomes idle. When the position of the filter cartridge is at an angle to the direction of the air flow, the air passes through the filter cartridge and is filtered. When the angle reaches 90°, the cross section passed through by the air is maximum, and harmful substances and particles in the air are trapped and retained by the filter cartridge. The switching of the filter cartridge between the above two states may be achieved by a rotation of the filter cartridge, or by changing a posture of the filter cartridge holder that fixes the filter cartridge.

In one embodiment, the purification unit has a space for housing the filter cartridge holder, wherein the filter cartridge holder occupies the space minimally when the filter cartridge is in the idle state, and the air passes through the non-occupied portion of the space in a manner of almost zero pressure loss.

In one embodiment, the filter cartridge holder includes a plurality of frames connected in series, and the plurality of frames are folded at junctions thereof such that the filter cartridge fixed to each of the frames is in an idle state. At least two frames connected in series are folded at a connection boundary, and a change in angular positions of the frames can be achieved, so that the filter cartridge mounted on the frame is switched between the working state and the idle state.

In one embodiment, the filter cartridge holder includes a stationary end that is connected to one of the frames and a movable end that is connected to another one of the frames; wherein when the actuator drives the movable end to move toward the stationary end, the filter cartridge changes toward the idle state; and when the actuator drives the movable end to move away from the stationary end, the filter cartridge changes toward the working state.

In one embodiment, the purification unit further includes a guider extending in a horizontal direction, and the actuator includes a drive belt and a driven block driven by the drive belt to move along the guider.

In one embodiment, the conveyer is configured to be extendable through the air inlet so that the filter cartridge holder moves from an interior of the housing to an exterior of the housing.

In one embodiment, the air inlet is configured to be open downward, and the conveyer includes a rope connected to the filter cartridge holder, and a roller for winding and unwinding the rope; or the conveyer includes a scissor mechanism connected to the filter cartridge holder, and the scissor mechanism controls the filter cartridge holder to move up and down.

In one embodiment, a plurality of filter cartridges are disposed in a stacked manner in the filter cartridge holder.

Another aspect of the present application is to provide an air purification system including the fan coil described above, wherein the purification unit is located inside the housing between the coil unit and the air inlet. The air purification system further includes: a human-machine interaction interface, and a controller in communication with the human-machine interaction interface, wherein the controller operates the filter cartridge holder to move via the conveyer or the actuator.

The fan coil according to the present application is integrated with an air purification function so that the incoming air is filtered first and then heated or cooled. Since the filter cartridge may be removed from the entire machine, the replacement of the filter cartridge becomes easy and convenient. The fan coil may be mounted above or in the ceiling so that it does not occupy the space. The filter cartridge holder carrying the filter cartridge is transported by the conveyer to a place accessible to personnel, so that not only convenience is provided, but also the safety for the user is ensured. The user may replace the type of filter cartridge as needed, so that the filtering form can be customized

During use, when the air purification function is turned on, the filter cartridge is in the working state, the air passing through is effectively filtered, and the filtering efficiency can be improved due to a large filtering area; and when the air purification function is turned off, the filter cartridge is stored, so that the air bypasses the filter cartridge and there will be no pressure loss.

Other aspects and features of the present application will become apparent from the following detailed description with reference to the drawings. However, it should be understood that the drawings are intended for purposes of illustration only, rather than defining the scope of the present application since it should be determined with reference to the appended claims. It should also be understood that the drawings are merely intended to conceptually illustrate the structure and flowchart described herein, and it is not necessary to draw the figures to the scale, unless otherwise specified.

### BRIEF DESCRIPTION OF THE DRAWINGS

The present application will be more fully understood from the following detailed description of specific embodiments with reference to the drawings. Identical elements are denoted by identical reference signs throughout the drawing, wherein:

FIG. 1 is a schematic view of an embodiment of a fan coil according to the present application;

FIGS. 2a-2b are schematic views of an embodiment of a conveyer of a fan coil according to the present application;

FIGS. 3a-3b are schematic views of another embodiment of a conveyer of a fan coil according to the present application;

FIGS. 4a-4b are schematic views showing the states in which the purification unit of the fan coil according to the present application turns on and off the filtering function respectively;

FIG. 5 is a schematic view of an embodiment of a filter cartridge holder of a fan coil according to the present application;

FIGS. 6a-6c are schematic views of another embodiment of a filter cartridge holder of a fan coil according to the present application, wherein FIG. 6a shows no filter cartridge is placed on the filter cartridge holder, FIG. 6b shows a filter cartridge is placed on the filter cartridge holder, and FIG. 6c is a top view of FIG. 6b; and

FIG. 7 is a schematic block diagram of the operation on the fan coil according to the present application.

### DETAILED DESCRIPTION OF THE EMBODIMENT(S) OF THE INVENTION

To help those skilled in the art precisely understand the subject matter of the present application, specific embodiments of the present application are described in detail below with reference to the accompanying drawings.

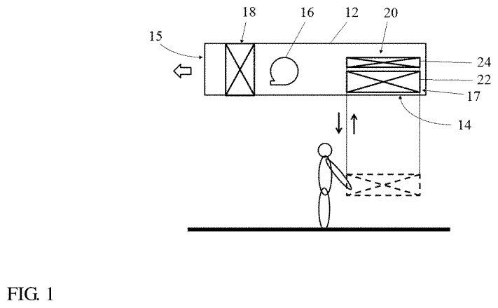

FIG. 1 shows a schematic view of a fan coil according to the present application. The fan coil includes a housing 12 that is provided with an air inlet 14 (also referred to as a return air inlet), a fan 16 and a coil unit 18. After entering the housing 12 via the air inlet 14, the air is guided through the coil unit 18 by the fan 16 and discharged from an air outlet 15. The coil unit 18 includes one or more groups of coils in which a cold medium or heat medium flows to exchange heat with air passing outside of the coils. A purification unit 20 is disposed in the vicinity of the air inlet 14 to filter the air before the air undergoes heat exchange. In the illustrated embodiment, the purification unit 20 is accommodated within the housing 12 and does not occupy a new space outside the housing 12. The purification unit 20 includes a filter cartridge holder 22 for supporting filter cartridges that may be mounted to the cartridge holder 22 or detached from the cartridge holder 22. The filter cartridge may be fixed in a variety of ways, such as mounting the filter cartridge to the holder thereof by screwing, or connecting the filter cartridge to the holder thereof by snap-fit, etc., all of which can facilitate the replacement of the filter cartridge. The filter cartridge holder 22 is connected to a conveyer 24 and is transported by the conveyer 24 to a place accessible to personnel to facilitate the above replacement operation on the filter cartridge holder 22. As shown, the fan coil is placed at a high level, such as above or in the ceiling of the room. The conveyer 24 serves to lower the filter cartridge holder 22 from a higher working position to a position where personnel can operate it.

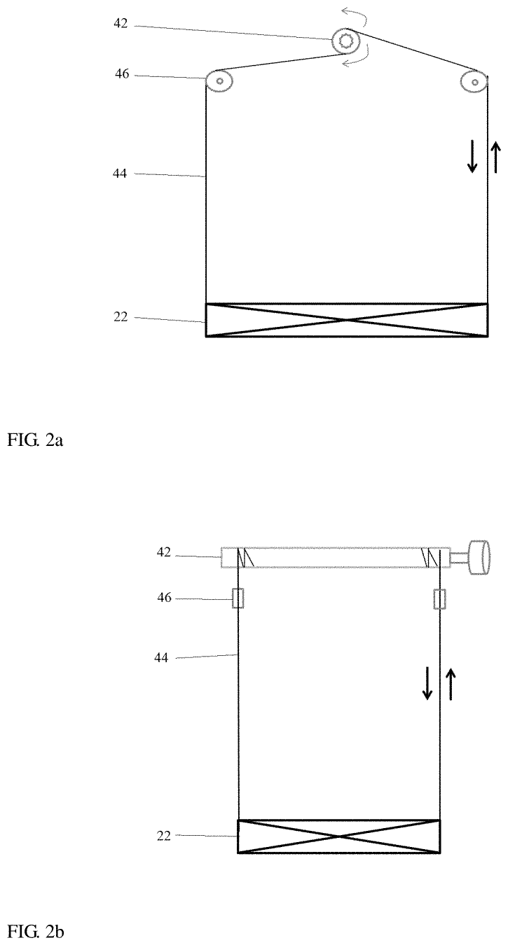

The conveyer 24 conveys the filter cartridge holder 22 in the vertical direction. FIGS. 2a-2b show an embodiment of the conveyer. The conveyer includes a roller 42 and a rope 44, and the vertical lifting/lowering of the filter cartridge holder 22 is realized by winding/unwinding the rope 44 by the roller 42. The roller 42 is driven by a motor, one end of the rope 44 is wound around the roller 42, and the other end is connected to the filter cartridge holder 22. The rope 44 is connected to each of the four diagonal corners of the filter cartridge holder 22. When the roller 42 is rotated in one direction, the roller 42 releases the rope 44 to lower the filter cartridge holder 24; and when the roller 42 is rotated in the opposite direction, the roller 42 retracts the rope 44 to lift the filter cartridge holder 24. The material of the rope 44 may be any material that facilitates winding and can bear loads, including but not limited to fabrics, synthetic fibers, metals or the like, and any combination thereof. The rope 44 may also have characteristics of being resistant to moisture and to high and low temperatures so that it does not age rapidly. The rope 44 is easy to store and has a low cost. The roller 42 is not necessarily driven directly by the motor, and may also be driven indirectly; the rope 44 may not necessarily be completely wound around the roller 42, for example, a rope take-up device may be provided to avoid the disorder in rope when winding the roller. As can be seen, the roller is used in conjunction with a fixed pulley 46 to vary the trace of the rope 44 and to further distribute the load. In addition to the fixed pulley, other mechanisms may of course be used instead.

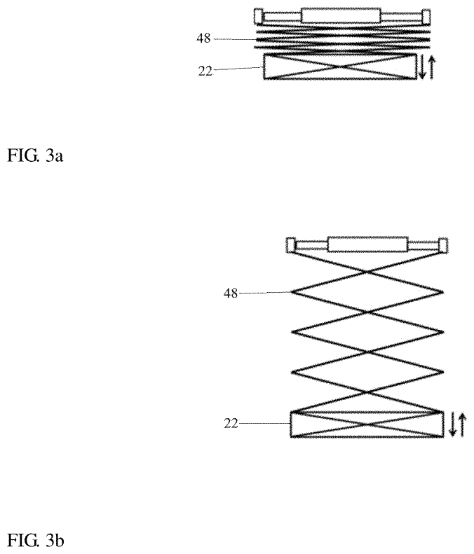

FIGS. 3a-3b show another embodiment of the conveyer. The conveyer includes a scissor mechanism 48. One end of the scissor mechanism 48 is disposed on the filter cartridge holder 22, and the other end is fixed in the housing. The mechanism has a deployed configuration and a retracted configuration, and the size thereof in the vertical direction is changed by changing the size thereof in the horizontal direction, whereby this deformation allows the filter cartridge holder to move in the vertical direction. When the mechanism is deployed, the filter cartridge holder is lowered, see FIG. 3b; and when the mechanism is retracted, the filter cartridge holder is raised, see FIG. 3a. The scissor mechanism 48 may be driven by a motor or by a pneumatic cylinder or a hydraulic cylinder. The scissor mechanism 48 provides a certain stiffness and stability to the filter cartridge holder 22 during movement of the filter cartridge holder 22 and during replacement of the filter cartridge.

In the embodiment shown in FIG. 1, the air inlet 14 is open downward. The conveyer 24 is mounted inside the housing 12 and operates under the actuation of any of the above-described driving modes. The conveyer 24 extends toward the outside of the housing 12 through the air inlet 14, and since it is connected to the filter cartridge holder 22, the filter cartridge holder 22 can be moved to a position where the filter cartridge is to be replaced. The conveyer 24 is fixedly mounted inside the housing 12 and may be positioned on an inner wall of the housing 12. For the housing shown in FIG. 1, a mount base of either the roller or the scissor mechanism may be mounted on the top or side wall of the interior of the housing so that the flow path of the air is not affected.

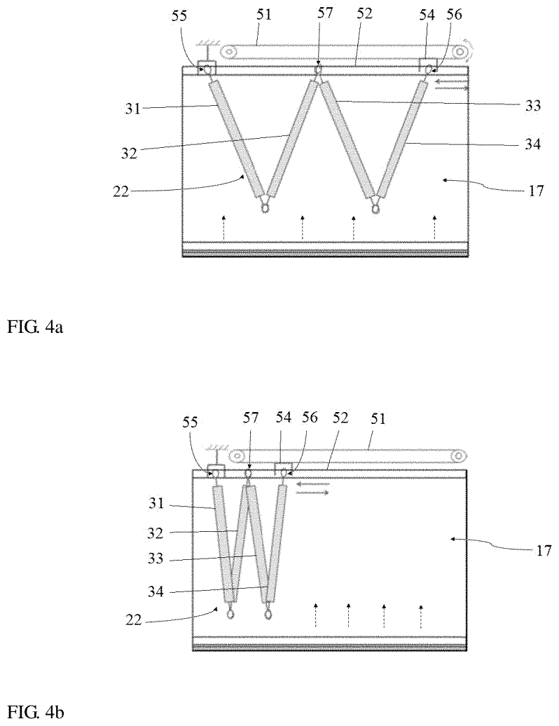

FIGS. 4a-4b show a schematic view of the structure of the filter cartridge holder. The filter cartridge holder is of a frame structure that carries the filter cartridge. As shown, the filter cartridge holder may include a plurality of frames 31, 32, 33 and 34 connected in series. These frames are connected in sequence, and each two adjacent frames are connected to each other by a hinge at a connection boundary thereof, whereby the filter cartridge holder is foldable. The frames 31, 32, 33 and 34 constituting the filter cartridge holder are each provided with a filter cartridge, and the filter cartridge is composed of a filter plate. Due to the movable connection between the frames 31, 32, 33 and 34, a positional state of the frames may be changed by folding themselves so as to change the positional state of the filter cartridge. FIGS. 4a-4b show a folding mode. The filter cartridge frame is driven by the actuator to be deployed or retracted in the horizontal direction. The actuator includes a drive belt 51 and a driven block 54 guided by the drive belt 51. The driven block 54 is fixed at one position of the drive belt 51 in any manner. As the drive belt 51 moves, the driven block 54 may move therewith, and when the drive belt 51 moves in two opposite directions, the driven block 54 reciprocates. In the illustrated embodiment, the filter cartridge holder is composed of four frames 31, 32, 33 and 34 that are hinged pairwise. One end of the frame 31 is connected to a fixed block, so the end 55 is stationary. One end of the frame 34 is connected to the driven block 54, so this end is a movable end 56. Other end, i.e., hinged end, between the frame 32 and the frame 33 is located in the middle of the fixed block and the driven block, and the hinged end is an intermediate end 57 (or an intermediate block). A guider 52 (e.g., a guide rail) is disposed passing through the intermediate end 57 and the driven block 54 so that the intermediate end 57 can move on the guide portion 52 along with the driven block 54. Thus, the four frames are lapped into a “W” shape as shown. This connection is similar to the installation of a curtain. When the driven block 54 moves, the intermediate end 57 is driven to move together, so that the filter cartridge holder has two configurations, i.e., a retracted configuration and a deployed configuration, and the filter cartridge fixed on the filter cartridge holder is switched between an idle state and a working state. FIG. 4a shows the deployed configuration of the filter cartridge holder, which may also be a state in which the filter cartridge holder is changed toward the deployed configuration, and FIG. 4b shows a state of the retracted configuration of the filter cartridge holder. In FIG. 4a, the dashed arrows indicate the flow path of the air, and the filter cartridge is oriented at an angle to the flow path of the air so that the air passing through the filter cartridge can be filtered. The filter cartridge holder can be at most expanded to a plane, in which case the filter cartridge is lateral and is at an angle of 90° to the flow path of the air, which presents the maximum cross-sectional area through which the air passes. In FIG. 4b, the filter cartridge is oriented to be consistent with the flow path of the air, and the air does not pass through the filter cartridge, but bypasses the filter cartridge, i.e., the cross-sectional area through which the air passes is zero. Since the filter cartridge does not participate in air filtration in this state, the filter cartridge is in the idle state. The movement of the filter cartridge holder causes a change in the position of the filter cartridge, thereby causing the filter cartridge to switch between the idle state and the working state. It is conceivable that a change in the position of the filter cartridge itself may cause such a switch.

In addition, the filter cartridge holder occupies a certain space 17 in the deployed state. This space 17 may be the space between the air inlet and the coil unit in the housing. When the filter cartridge holder is retracted, as shown in FIG. 4b, since the filter cartridge holder 22 has a reduced folding volume, it occupies only a small portion of the above space 17. In this case, air flows through the other portion of the space 17 that is not occupied by the filter cartridge holder 22, and there is no loss in the pressure because it is not affected by the differential pressure resistance generated by the filtration. The gas flow which passes in this way facilitates subsequent heat exchange processing. When the air needs to be filtered, the purification function is turned on, the filter cartridge holder is deployed, and the air is filtered by the filter cartridge; and when the air does not need to be filtered, the purification function is turned off, the filter cartridge holder is retracted and folded to give way to the path of the air flow so that the air bypasses the filter cartridge and there will be no pressure loss.

The filter cartridge holder may also be composed of fewer or more frames, that is, there can be either no intermediate end or a plurality of intermediate ends between the fixed end and the movable end. In the actuator, the drive belt may be driven by a motor. The drive belt may also be driven by other transmission methods instead.

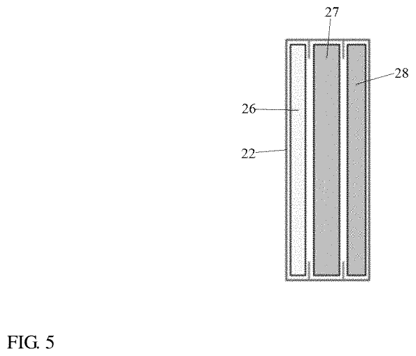

FIG. 5 shows a schematic view of the structure of the filter cartridge holder. In the illustrated embodiment, the filter cartridge holder carries three filter cartridges 26-28. The filter cartridge holder is formed into a drawer frame structure, the filter cartridges are placed in the drawer, and the bottom of the drawer is hollow. The filter cartridges may be in the form of screens or vents of different specifications, or may use adsorbent or chemical materials. It can be physical filtration or chemical filtration. Thus, the user may conduct a targeted replacement of the filter cartridge based on actual needs, such as removing PM2.5, formaldehyde, or VOC. Filter cartridges of the same type may be placed in the filter cartridge holder, or various types of filter cartridges may be placed in the filter cartridge holder.

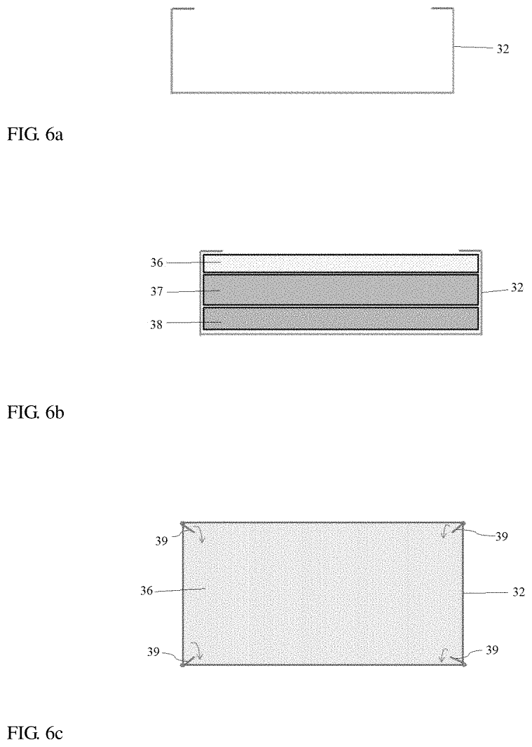

FIGS. 6a-6b show schematic views of another embodiment of the filter cartridge holder. FIG. 6a shows that no filter cartridge is placed in the filter cartridge holder, and FIG. 6b shows the filter cartridge is placed in the filter cartridge holder. As can be seen from the figures, the filter cartridge holder 32 is a drawer type frame, and a plurality of filter cartridges are placed in a stacked manner in the filter cartridge holder 32. As shown in FIG. 6b, three different filter cartridges 36, 37 and 38 are stacked in the filter cartridge holder 32. When there is a filter cartridge in the filter cartridge holder 32, the fan coil has a filtering function to filter the passing air. When the filter cartridge is removed from the filter cartridge holder 32, the filter function of the fan coil is turned off. These filter cartridges are not foldable, and the filtering function is turned on and off manually, that is, the filter cartridge holder is first laid down by the conveyer, and then the filter cartridges are put in or taken out. The filter cartridges are disposed in the housing in the manner shown in the figure, which can reduce the height in the vertical direction, and is advantageous for saving space in this direction, thus making it particularly suitable for the case where the installation space for the filter cartridge is limited. With continued reference to FIG. 6c, the fixation of the filter cartridge relative to the filter cartridge holder may be achieved by pivotal clamping. As shown, a rotatable slider 39 is disposed on each of the four corners of the filter cartridge holder. When the four sliders 39 are moved inward toward the center, the filter cartridges can be fixed on the filter cartridge holder; and when the four sliders 39 are moved outward away from the center, the fixation of the filter cartridges can be released.

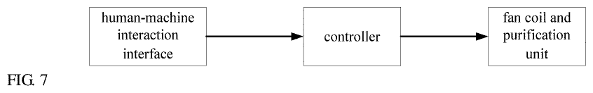

The user may also turn the purification function on and off autonomously. As shown in FIG. 7, an activation command is sent through a human-machine interaction interface, such as a remote controller or a temperature control board, and the command is transmitted to a controller that is communicatively connected to the human-machine interaction interface. Then, the controller sends an instruction to the actuator of the purification unit to drive the filter cartridge holder to deploy, so that the filter cartridge is in the working state. When the filter cartridge needs to be replaced, the user sends a replacement command through the human-machine interaction interface, and the controller moves the filter cartridge holder out of the housing by controlling the conveyer until the filter cartridge holder is lowered to the replacement position. Similarly, after the filter cartridge is replaced, the user may still send a command to raise the filter cartridge holder until it is retracted into the housing. When no filtering is required, the user's command is transmitted to the controller, which controls the filter cartridge holder to retract, allowing air to pass without pressure loss. The controller may also automatically control the deployment or retraction of the filter cartridge according to the real-time parameters of the environment.

Principles of the present application are described in connection with the specific embodiments of the present application that have been shown and described in detail, but it should be understood that the present application can be implemented in other ways without departing from the principles.

What is claimed is:

1. A fan coil, comprising:
a housing, wherein the housing is provided with an air inlet, a fan inside the housing which air enters via the air inlet and a coil unit; and
a purification unit located near the air inlet for filtering air, wherein the purification unit comprises a filter cartridge holder that detachably fixes a filter cartridge, and a conveyer that is attached to the filter cartridge holder and moves the filter cartridge to a place accessible to personnel.

2. The fan coil according to claim 1, wherein the purification unit further comprises an actuator which drives the filter cartridge fixed to the filter cartridge holder to change between an idle state and a working state, wherein in the idle state, the filter cartridge is oriented to follow an air path so that air bypasses the filter cartridge; and in the working state, the filter cartridge is oriented to cross the air path so that air passes through the filter cartridge.

3. The fan coil according to claim 2, wherein the purification unit has a space for housing the filter cartridge holder, the filter cartridge holder which is folded occupies a portion of the space when the filter cartridge is in the idle state, and the air passes through the non-occupied other portion of the space.

4. The fan coil according to claim 2, wherein the filter cartridge holder comprises a plurality of frames connected in series, and the plurality of frames are folded at junctions thereof such that the filter cartridge fixed to each of the frames is in the idle state.

5. The fan coil according to claim 4, wherein the filter cartridge holder comprises a stationary end that is connected to one of the frames and a movable end that is connected to another one of the frames; when the actuator drives the movable end to move toward the stationary end, the filter cartridge changes toward the idle state; and when the actuator drives the movable end to move away from the stationary end, the filter cartridge changes toward the working state.

6. The fan coil according to claim 5, wherein the purification unit further comprises a guider extending in a horizontal direction, and the actuator comprises a drive belt and a driven block driven by the drive belt to move along the guider.

7. The fan coil according to claim 1, wherein the conveyer is configured to be extendable through the air inlet so that the filter cartridge holder moves from an interior of the housing to an exterior of the housing.

8. The fan coil according to claim 1, wherein the air inlet is configured to be open downward, and the conveyer comprises a rope connected to the filter cartridge holder, and a roller for winding and unwinding the rope.

9. The fan coil according to claim 1, wherein the conveyer comprises a scissor mechanism connected to the filter cartridge holder, and the scissor mechanism controls the filter cartridge holder to move up and down.

10. An air purification system, comprising:
the fan coil according to claim 1, wherein the purification unit is located inside the housing between the coil unit and the air inlet, the air purification system further comprising:
a human-machine interaction interface; and
a controller in communication with the human-machine interaction interface, wherein the controller operates the filter cartridge holder to move via the conveyer or the actuator.
